(19) United States
(12) Patent Application Publication
(10) Pub. No.: US 2022/0066686 A1
(43) Pub. Date: Mar. 3, 2022

(54) NON-VOLATILE MEMORY AND WRITING METHOD THEREOF

(71) Applicant: Gigadevice Semiconductor (Beijing) Inc., Beijing (CN)

(72) Inventor: Minyi CHEN, Beijing (CN)

(73) Assignee: Gigadevice Semiconductor (Beijing) Inc., Beijing (CN)

(21) Appl. No.: 17/164,856

(22) Filed: Feb. 2, 2021

(30) Foreign Application Priority Data
Sep. 1, 2020 (CN) 202010903125.0

(51) Int. Cl. G06F 3/06

(52) U.S. Cl. CPC G06F 3/0655; G06F 3/0604; G06F 3/0679

(57) ABSTRACT

A non-volatile memory includes: a plurality of word lines; a plurality of bit lines; a plurality of pages; and a controller. Each of the plurality of pages includes a plurality of data storage units and at least one flag storage unit. The controller is configured to perform: writing a data stream into the plurality of data storage units; setting a flag in response to a number of bits “0” in the data stream and a number of bits “1” in the data stream; and writing the flag into the plurality of flag storage units, where the flag indicates whether the data stream is inversed. A writing method and a reading method of a non-volatile memory are also provided.

### RELATED APPLICATION

This application claims the benefit of priority of Chinese Patent Application No. 202010903125.0 filed on Sep. 1, 2020, the contents of which are incorporated herein by reference in their entirety.

### FIELD AND BACKGROUND OF THE INVENTION

The present disclosure relates to the memory technical field, and more particularly to a non-volatile memory and a writing method thereof.

A Fowler-Nordheim tunneling (FN tunneling) mechanism and a channel hot electron injection (CHEI) mechanism are used for write operations and erase operations of flash memories. The two mechanisms relate to electrons passing a tunnel oxide layer. The write/erase operation may cause traps and defects in the tunnel oxide layer due to electrical stress. The traps and the defects result in a stress induced leakage current (SILC). As such, flash memories suffer the problem of data retention.

Consequently, there is a need to solve the above-mentioned problem in the existing art.

### SUMMARY OF THE INVENTION

Embodiments of the present disclosure provide a non-volatile memory and a writing method thereof.

A non-volatile memory provided by the present disclosure includes: a plurality of word lines; a plurality of bit lines; a plurality of storage units; and a controller. The plurality of storage units are addressed by the plurality of word lines and the plurality of bit lines, and the plurality of storage units include a plurality of data storage units and a plurality of flag storage units. The controller is configured to perform: writing a data stream into the plurality of data storage units; setting a flag in response to a number of bits “0” in the data stream and a number of bits “1” in the data stream; and writing the flag into the plurality of flag storage units, where the flag indicates whether the data stream is inversed.

A writing method of a non-volatile memory includes: writing a data stream into a plurality of data storage units; setting a flag in response to a number of bits “0” in the data stream and a number of bits “1” in the data stream, wherein the flag indicates whether the data stream is inversed; and writing the flag into a plurality of flag storage units.

A non-volatile memory provided by the present disclosure includes: a plurality of pages and a controller. Each of the plurality of pages includes a plurality of data storage units and at least one flag storage unit. The controller is configured to perform: determining whether a number of bits “0” in a data stream is greater than a number of bits “1” in the data stream; in response to determining that the number of bits “0” in the data stream is greater than the number of bits “1” in the data stream, inversing the data stream, setting a flag as a first value, and writing the inversed data stream and the flag into a target page among of the plurality of pages; and in response to determining that the number of bits “0” in the data stream is less than or equal to the number of bits “1” in the data stream, setting the flag as a second value, and writing the data stream and the flag into the target page among of the plurality of pages.

A writing method of a non-volatile memory provided by the present disclosure includes: determining whether a number of bits “0” in a data stream is greater than a number of bits “1” in the data stream; in response to determining that the number of bits “0” in the data stream is greater than the number of bits “1” in the data stream, inversing the data stream, setting a flag as a first value, and writing the inversed data stream and the flag into a target page; and in response to determining that the number of bits “0” in the data stream is less than or equal to the number of bits “1” in the data stream, setting the flag as a second value and writing the data stream and the flag into the target page.

A reading method of a non-volatile memory provided by the present disclosure includes: reading a data stream from data storage units, and reading a flag from a flag storage unit; inversing the data stream and using the inversed data stream as a read result, when the flag is a first value; and using the data stream as the read result, when the flag is a second value.

In the present disclosure, when the number of bits “0” in the data stream is greater than the number of bits “1” in the data stream, the data stream is inversed, and the inversed data stream is written into the target page. Therefore, the number of memory cells enduring FN tunneling or CHEI is reduced, and the overall data retention of the non-volatile memory is improved.

### BRIEF DESCRIPTION OF THE SEVERAL VIEWS OF THE DRAWINGS

FIG. 1 illustrates a functional block diagram of a non-volatile memory in accordance with an embodiment of the present disclosure.

FIG. 2 illustrates a block of a memory array in FIG. 1.

FIG. 3 illustrates a page of the block in accordance with an embodiment of the present disclosure.

FIG. 4 illustrates a page of the block in accordance with another embodiment of the present disclosure.

FIG. 5 illustrates a data stream and a flag in accordance with an embodiment of the present disclosure.

FIG. 6 illustrates a data stream and a flag in accordance with another embodiment of the present disclosure.

FIG. 7 illustrates a flag stored in flag storage units in accordance with another embodiment.

FIG. 8 illustrates a detailed flowchart of a writing method of a non-volatile memory in accordance with an embodiment of the present disclosure.

FIG. 9 illustrates a flowchart of a reading method of a non-volatile memory in accordance with an embodiment of the present disclosure.

### DESCRIPTION OF SPECIFIC EMBODIMENTS OF THE INVENTION

Hereinafter, exemplary embodiments of the present disclosure will be described with reference to the accompanying drawings for illustrating specific embodiments which can be carried out by the present disclosure.

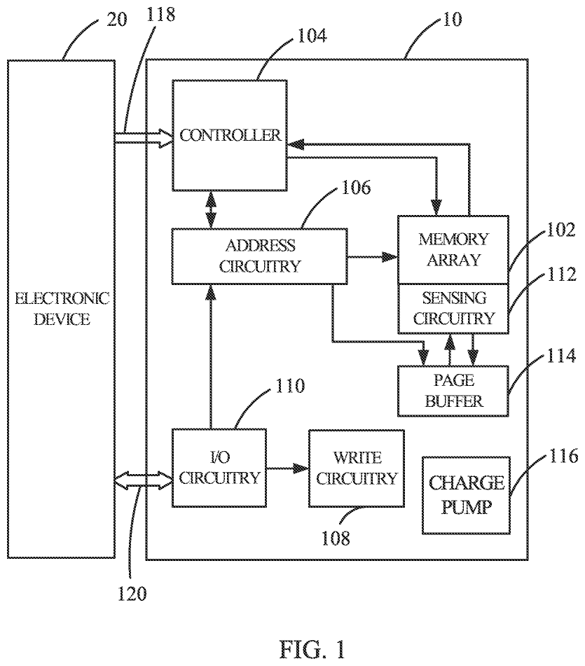

FIG. 1 illustrates a functional block diagram of a non-volatile memory 10 in accordance with an embodiment of the present disclosure. The non-volatile memory 10 is electrically connected to an electronic device 20. The non-volatile memory 10 can perform bidirectional data communication with the electronic device 20. The non-volatile memory 10, for example, may be a universal serial bus drive, a portable storage device, or a memory card. The electronic device 20 is a user's device, for example, a mobile phone, a tablet, a notebook, or a camera.

The non-volatile memory 10 includes a memory array 102, a controller 104, an address circuitry 106, a write circuitry 108, an input/output (I/O) circuitry 110, a sensing circuitry 112, a page buffer 114, and a charge pump 116. The non-volatile memory 10, for example, may be a NOR flash memory or a NAND flash memory. The following description is made by taking the NAND flash memory as an example.

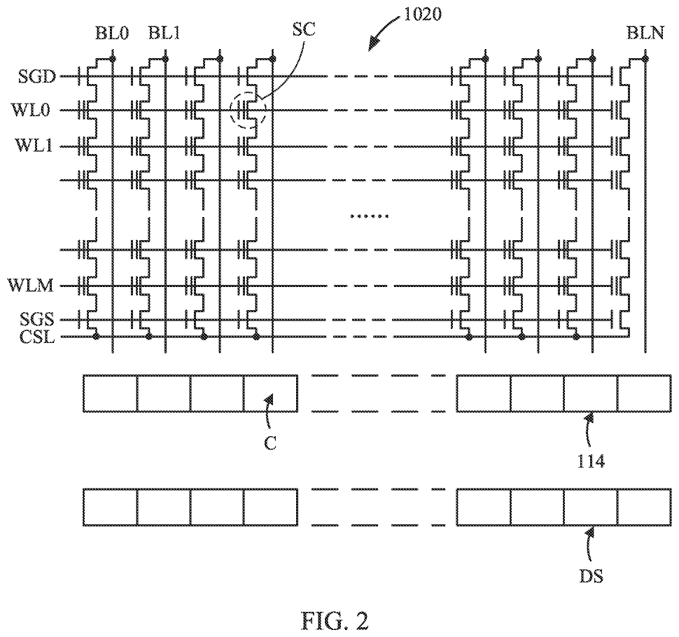

The memory array 102 of the non-volatile memory 10 includes a plurality of blocks 1020. FIG. 2 illustrates a block 1020 of the memory array 102 in FIG. 1. As shown in FIG. 2, each block 1020 includes a plurality of word lines WL0-WLM, a plurality of bit lines BL0-BLN, and a plurality of storage units SC. Each of the word lines WL0-WLM corresponds to one page. The storage units SC of each page include a plurality of data storage units and one or more flag storage units. In some embodiments, the storage units SC of each page further include a plurality of error correction code (ECC) storage units and a plurality of redundant storage units. The error correction code storage units are configured to store error correction codes. The redundant storage units are configured to substitute failure data storage units. The storage units SC are addressed by the word lines WL0-WLM and the bit lines BL0-BLN. In detail, all storage units SC connected to the same word line together form one page. All pages connected to the word lines WL0-WLM together form one block.

Each storage unit SC, for example, is a transistor having a floating gate electrode or a charge trapping layer. Each storage unit SC can be a single-level cell (SLC) for storing one bit of data, a multi-level cell (MLC) for storing two bits of data, a tri-level cell (TLC) for storing three bits of data, or a quad-level cell (QLC) for storing four bits of data. Taking the storage units SC as SLCs for example. The storage units SC can be in a programmed state or an unprogrammed state (also referred to as an erase state). The storage units SC in the programmed state store data “0”. The storage units SC in the unprogrammed state store data “1”. In a write operation (also referred to as a program operation), a voltage applied to a control gate of one storage unit SC causes a tunnel current to pass a tunnel oxide layer, thereby injecting electrons into a floating gate electrode. Accordingly, the floating gate electrode is in a negative charge state representing a logical value “0”. Data stored by the storage unit SC in the programmed state is set as “0”. In an erase operation, a voltage applied to a semiconductor substrate of one storage unit SC releases electrons stored in the floating gate electrode, so that the floating gate electrode is in a neutral state (or a positive charge state) representing a logical value “1”. As such, data stored by the storage unit SC in the unprogrammed state is set as “1”.

The controller 104 is configured to decode an instruction which the electronic device 20 transmits via a control bus 118, execute the instruction of the electronic device 20, and/or access the memory array 102. The instruction is configured to execute an operation on the memory array 102. The operation at least includes a read operation, a write operation, an erase operation, and the like.

The address circuitry 106 is configured to latch address signals from the input/output circuitry 110 and decode the address signals to access the memory array 102. The electronic device 20 is configured to transmit the address signals to the input/output circuitry 110 via a data bus 120.

The write circuitry 108 is configured to execute a write operation. The sensing circuitry 122 is connected to the bit lines BL0-BLN and configured to execute a read operation.

The page buffer 114 is configured to store data read from each page and data to be written into the memory array 102. The controller 104 is configured to determine, according to the data in the page buffer 114, word line voltages required to be applied to the word lines WL0-WLM in a write operation, a read operation, and an erase operation.

The charge pump 116 is configured to provide word line voltages for the word lines WL0-WLM, bit line voltages for the bit lines BL0-BLN, and a substrate voltage, when a write operation, a read operation, or an erase operation is executed.

As shown in FIG. 2, each unit C of the page buffer 114 corresponds to one storage unit SC. For a NAND flash memory, an erase operation is executed in units of blocks, and a read operation and a write operation are executed in units of pages.

When an erase operation is executed, all of the word lines WL0-WLM are grounded, all of the bit lines BL0-BLN are floating, and an erase voltage is applied to the semiconductor substrate. In one embodiment, the controller 104 directly executes the erase operation on a target block 1020 of the memory array 102 after receiving an erase instruction, and a pre-program operation is not executed before the erase operation is executed.

For a NAND flash memory, it is necessary to execute an erase operation before a write operation, even if the storage units SC are all in the unprogrammed state. When the write operation is executed, a program voltage is applied to a word line corresponding to a selected page (a target page) and a pass voltage is applied to word lines corresponding to unselected pages. When the units C of the page buffer 114 store “0”, the bit lines corresponding to the units C which store “0” are grounded. When the units C of the page buffer 114 store “1”, a program inhibit voltage is applied to the bit lines corresponding to the units C which store “1”.

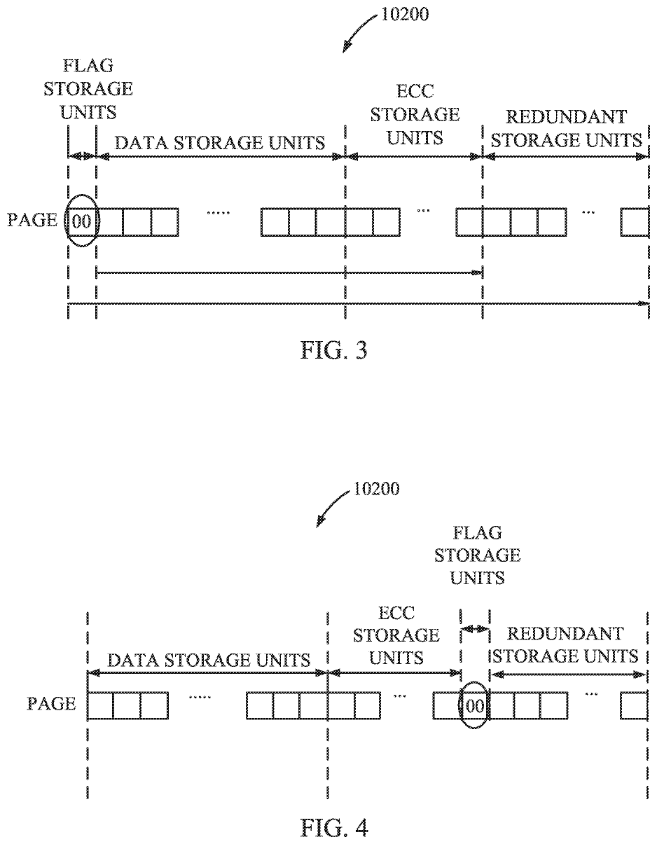

FIG. 3 illustrates a page 10200 of the block 1020 in accordance with an embodiment of the present disclosure. As shown in FIG. 3, the storage units of each page (corresponding to one word line) include the data storage units, the error correction code storage units, the redundant storage units, and the flag storage units.

In order to prevent the problem of data retention resulted from a stress induced leakage current, the controller 104 of the present disclosure is configured to perform: writing a data stream DS in FIG. 2 into the data storage units SC; setting a flag in response to a number of “0” in the data stream DS and a number of “1” in the data stream DS; and writing the flag into the flag storage units. The data stream DS includes a plurality of bits, and each bit is either 1 or 0. The flag indicates whether the data stream DS is inversed. Inversing the data stream DS means a bit flip operation, that is the bit with a value “0” is flipped to “1”, and data “1” in the data stream DS is flipped to “0”. The data stream DS refers to data allocated to one page of the memory array 102. For example, the controller 104 receives data to be written (a size of the data to be written is usually greater than a size of one page) from the electronic device 20 and then allocates the data into multiple pages.

The controller 104 stores the data stream DS allocated to the target page into the page buffer 114. The controller 104 determines the number of bits “0” in the data stream DS and the number of bits “1” in the data stream DS. When the number of bits “0” in the data stream DS is greater than the number of bits “1” in the data stream DS, the data stream DS in the page buffer 114 is inversed and the flag is set as a first value.

When the number of bits “0” in the data stream DS is less than the number of bits “1” in the data stream DS, the data stream DS is kept without being inversed and the flag is set as a second value.

When the number of bits “0” in the data stream DS is equal to the number of bits “1” in the data stream DS, the data stream DS is kept without being inversed and the flag is set as the second value.

The non-volatile memory of the present disclosure determines whether to inverse the data of the written data stream according to the number of bits “0” in the data stream and the number of bits “1” in the data stream, thereby reducing the stress induced leakage current to avoid the problem of data retention. Furthermore, the flag is written into the flag storage units to indicate whether the data stream is inversed. When the data stream is read, the read data stream can be restored to the correct (original) data stream.

As mentioned above, when the number of bits “0” in the data stream DS is greater than the number of bits “1” in the data stream DS, the data stream DS is inversed. Since the data stream DS is inversed, the number of bits “0” in the inversed data stream is less than the number of bits “1” in the inversed data stream. For bit “0”, FN tunneling or CHEI is needed to inject electrons into the floating gate of the storage unit corresponding to the bit “0”. After the data stream DS is inversed, the number of bits “0” is reduced. As such, the stress induced leakage current can be decreased to avoid the problem of data retention.

In one embodiment, the plurality of storage units are arranged in a plurality of rows. The flag storage units are first storage units of the plurality of rows, as shown in FIG. 3. That is, the flag storage units are located ahead the data storage units. It is noted that FIG. 3 only illustrates the position of the flag storage units in a storage page but does not limit a bit number of the flag.

In another embodiment, the flag storage units are located after the plurality of error correction code storage units, as shown in FIG. 4. It is noted that FIG. 4 only illustrates the position of the flag storage units in a page but does not limit a bit number of the flag.

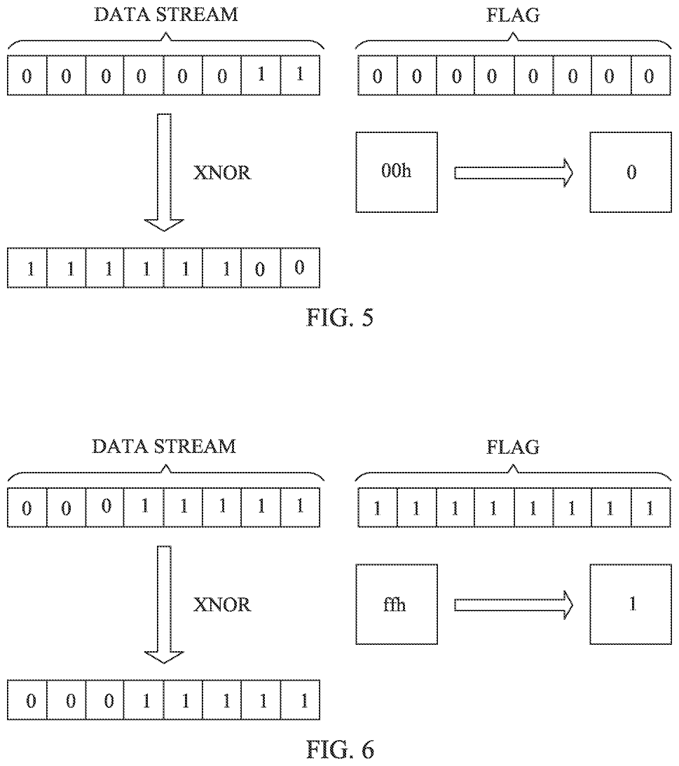

Please refer to FIG. 5 and FIG. 6. FIG. 5 illustrates a data stream and a flag in accordance with an embodiment of the present disclosure. FIG. 6 illustrates a data stream and a flag in accordance with another embodiment of the present disclosure.

As shown in FIG. 5, the data stream is “00000011”. The number of bits “0” is greater than the number of bits “1”. Accordingly, the flag is set as a first value, for example, “00000000” (00h).

As shown in FIG. 6, the data stream is “00011111”. The number of bits “0” is less than the number of bits “1”. Accordingly, the flag is set as a second value, for example, “11111111” (11h).

In another embodiment, the flag is one bit. If the number of bits “0” is greater than the number of bits “1”, the flag is set as 0, and if the number of bits “0” is less than the number of bits “1”, the flag is set as 1. An XNOR operation is performed on each bit of the original data stream and the flag, and the obtained data stream is stored in the page buffer, and the write operation is performed according to the obtained data stream stored in the page buffer.

In yet another embodiment, the flag is one bit. If the number of bits “0” is greater than the number of bits “1”, the flag is set as 1, and if the number of bits “0” is less than the number of bits “1”, the flag is set as 0. An XOR operation is performed on each bit of the original data stream and the flag, and the obtained data stream is stored in the page buffer, and the write operation is performed according to the obtained data stream stored in the page buffer.

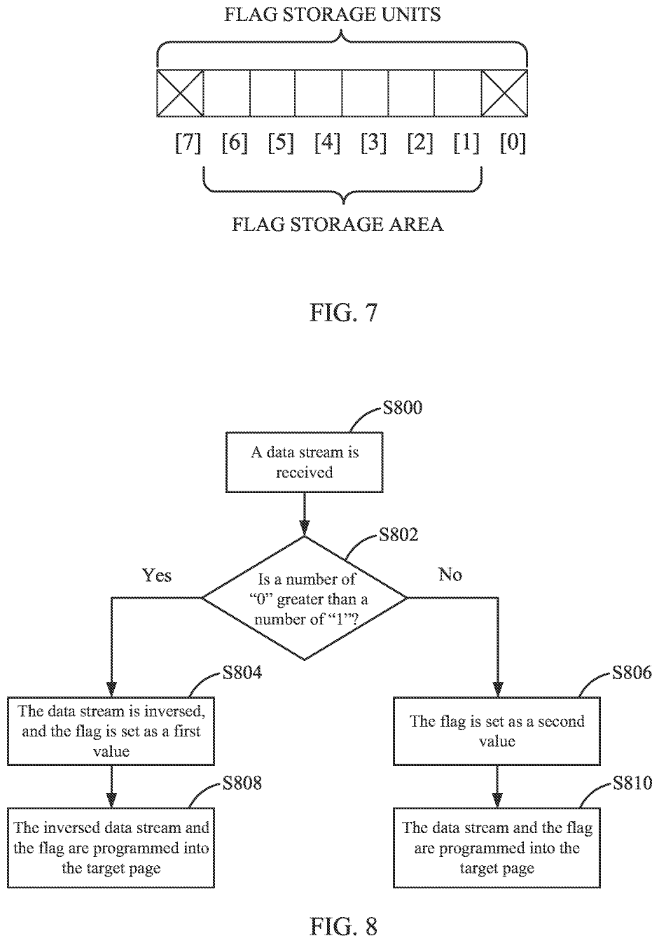

The flag can be, for example, one bit or one byte. Certainly, the bit number of the flag can also be one of other positive integers. In some embodiments, the bit number of the flag is less than the number of the flag storage units. In some embodiments, in each page, the flag is stored in the flag storage units excluding the first one of the flag storage units and the last one of the flag storage units. For example, the flag is stored in flag storage units between the first one of the flag storage units and the last one of the flag storage units. Please refer to FIG. 7. FIG. 7 illustrates a flag stored in flag storage units in accordance with another embodiment. As shown in FIG. 7, one page includes eight flag storage units [0]-[7]. Since the flag storage units [0] and [7] are easily affected by operations of other storage units, the flag storage units [0] and [7] are not used for storing the flag. The flag includes 6 bits. The flag is stored in the flag storage units [1]-[6]. That is, a flag storage area includes the flag storage units [1]-[6].

An embodiment of the present provides a writing method of a non-volatile memory. The writing method includes the following steps.

In one step, a data stream is written into data storage units of a target page.

In one step, a flag is set in response to a number of bits “0” in the data stream and a number of bits “1” in the data stream. The flag indicates whether the data stream is inversed.

In one step, the flag is written into flag storage units of the target page.

It should be understood that a sequence of the above-mentioned steps is not limited. For example, the step of writing the data stream into the data storage units and the step of writing the flag into the flag storage units are performed at the same time.

The step of setting the flag in response to the number of bits “0” in the data stream and the number of bits “1” in the data stream includes: determining whether the number of bits “0” in the data stream is greater than the number of bits “1” in the data stream; inversing the data stream and setting the flag as a first value, when the number of bits “0” in the data stream is greater than the number of bits “1” in the data stream; keeping the data stream without being inversed and setting the flag as a second value, when the number of bits “0” in the data stream is less than the number of bits “1” in the data stream; and keeping the data stream without being inversed and setting the flag as the second value, when the number of bits “0” in the data stream is equal to the number of bits “1” in the data stream.

In detail, the controller 104 receives data from the electronic device 20 and determines that the data stream is required to be written into the target page. The controller 104 stores the data stream into the page buffer 114. The controller 104 determines whether to inverse the data stream according to the number of bits “0” in the data stream and the number of bits “1” in the data stream and sets the value of the flag. For example, the inversion of the data stream in the page buffer 114 can be implemented by an inverter. Then, the controller 104 programs the storage units SC in the target page according to the flag and the data stream or the inversed data stream in the page buffer 114.

Another embodiment of the present disclosure further provides a writing method of a non-volatile memory. The writing method includes the following steps. The controller 104 determines a number of bits “0” in a data stream and a number of bits “1” in the data stream. In response to determining that the number of bits “0” in the data stream is greater than the number of bits “1” in the data stream, the data stream is inversed, the flag is set as a first value, and the flag and the inversed data stream are written into the target page. In response to determining that the number of bits “0” in the data stream is less than or equal to the number of bits “1” in the data stream, the data stream is kept without being inversed, the flag is set as a second value, and the flag and the data stream are written into the target page.

In one embodiment, the controller 104 firstly stores the data stream in the page buffer 114. The controller 104 inverses the data stream via an inverter, stores the set flag in the page buffer 114, and then executes a program operation on the target page according to the data stored in the page buffer 114. Through the program operation, the flag and the data stream or the inversed data stream are written into the target page.

In one embodiment, the flag is written into the flag storage units of the target page, and the data stream or the inversed data stream is written into the data storage units of the target page.

In one embodiment, a number of the flag storage units is greater than a bit number of the flag, and the flag is stored in flag storage units between a first one of the flag storage units and a last one of the flag storage units.

Please refer to FIG. 8. FIG. 8 illustrates a detailed flowchart of a writing method of a non-volatile memory in accordance with an embodiment of the present disclosure.

In operation S800, a data stream to be written into a target page is received.

In operation S802, it is determined whether a number of bits “0” in the data stream is greater than a number of bits “1” in the data stream. When the number of bits “0” in the data stream is greater than the number of bits “1” in the data stream, operation S804 is performed. When the number of bits “0” in the data stream is less than or equal to the number of bits “1” in the data stream, operation S806 is performed.

In operation S804, the data stream is inversed, and a flag is set as a first value. Next, the method proceeds to operation S808.

In operation S806, the flag is set as a second value. Next, the method proceeds to operation S810.

In operation S808, the inversed data stream and the flag are written (programmed) into the target page.

In operation S810, the data stream and the flag are written (programmed) into the target page.

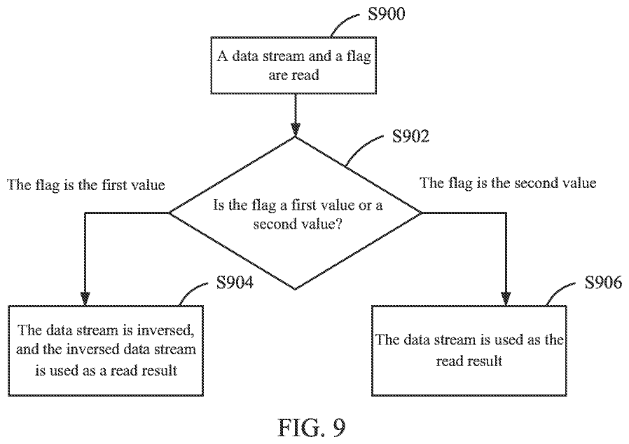

Please refer to FIG. 9. FIG. 9 illustrates a flowchart of a reading method of a non-volatile memory in accordance with an embodiment of the present disclosure.

In operation S900, a data stream is read from data storage units, and a flag is read from flag storage units.

In operation S902, it is determined whether the flag is a first value or a second value. When the flag is the first value, the method proceeds to operation S904. When the flag is the second value, the method proceeds to operation S906.

In operation S904, the data stream is inversed, and the inversed data stream is used as a read result.

When the flag is the first value, it represents that the data stream is inversed. Accordingly, the read data stream is inversed to be restored to the correct (original) data stream.

In operation S906, the data stream is used as the read result.

When the flag is the second value, it represents that the data stream is not inversed. Accordingly, the read data stream is the written data stream.

In one embodiment, the data stream read from the data storage units is stored in a page buffer temporarily. When the flag is the first value, an inversion operation is executed on the data stream stored in the page buffer.

In the non-volatile memory and the writing method and the reading method thereof, it is determined whether to inverse the written data stream according to the number of bits “0” in the data stream and the number of bits “1” in the data stream, thereby reducing the stress induced leakage current to avoid the problem of data retention. Furthermore, the flag is written into the flag storage units to indicate whether the data stream is inversed. When the data stream is read, the inversed data stream can be restored to the correct (original) data stream according to the flag.

In summary, although the present disclosure has been provided in the preferred embodiments described above, the foregoing preferred embodiments are not intended to limit the present disclosure. Those skilled in the art, without departing from the spirit and scope of the present disclosure, may make modifications and variations, so the scope of the protection of the present disclosure is defined by the claims.

What is claimed is:

1. A non-volatile memory, comprising:
a plurality of word lines;
a plurality of bit lines;
a plurality of storage units, wherein the plurality of storage units are addressed by the plurality of word lines and the plurality of bit lines, and the plurality of storage units comprise a plurality of data storage units and a plurality of flag storage units; and
a controller configured to perform:
writing a data stream into the plurality of data storage units;
setting a flag in response to a number of bits “0” in the data stream and a number of bits “1” in the data stream; and
writing the flag into the plurality of flag storage units, wherein the flag indicates whether the data stream is inversed.

2. The non-volatile memory of claim 1, wherein the plurality of storage units are arranged in a plurality of rows, and the flag storage units are first storage units of the plurality of rows.

3. The non-volatile memory of claim 1, wherein the plurality of storage units further comprise a plurality of error correction code storage units, and the flag storage units are located after the plurality of error correction code storage units.

4. The non-volatile memory of claim 1, wherein when the number of bits “0” in the data stream is greater than the number of bits “1” in the data stream, the data stream is inversed and the flag is set as a first value;
when the number of bits “0” in the data stream is less than the number of bits “1” in the data stream, the data stream is kept without being inversed and the flag is set as a second value; and
when the number of bits “0” in the data stream is equal to the number of bits “1” in the data stream, the data stream is kept without being inversed and the flag is set as the second value.

5. The non-volatile memory of claim 1, wherein a number of the plurality of flag storage units is greater than a bit number of the flag, and the flag is stored in flag storage units between a first one of the plurality of flag storage units and a last one of the plurality of flag storage units.

6. A writing method of a non-volatile memory, comprising:
writing a data stream into a plurality of data storage units;
setting a flag in response to a number of bits “0” in the data stream and a number of bits “1” in the data stream, wherein the flag indicates whether the data stream is inversed; and
writing the flag into a plurality of flag storage units.

7. The writing method of the non-volatile memory of claim 6, wherein the step of setting the flag in response to the number of bits “0” in the data stream and the number of bits “1” in the data stream comprises:
determining whether the number of bits “0” in the data stream is greater than the number of bits “1” in the data stream;
inversing the data stream and setting the flag as a first value, when the number of bits “0” in the data stream is greater than the number of bits “1” in the data stream;
keeping the data stream without being inversed and setting the flag as a second value, when the number of bits “0” in the data stream is less than the number of bits “1” in the data stream; and
keeping the data stream without being inversed and setting the flag as the second value, when the number of bits “0” in the data stream is equal to the number of bits “1” in the data stream.

8. The writing method of the non-volatile memory of claim 6, wherein a number of the plurality of flag storage units is greater than a bit number of the flag, and the flag is stored in flag storage units between a first one of the plurality of flag storage units and a last one of the plurality of flag storage units.

9. A non-volatile memory, comprising:
a plurality of pages, each comprising a plurality of data storage units and at least one flag storage unit; and
a controller configured to perform:
determining whether a number of bits “0” in a data stream is greater than a number of bits “1” in the data stream;
in response to determining that the number of bits “0” in the data stream is greater than the number of bits “1” in the data stream, inversing the data stream, setting a flag as a first value, and writing the inversed data stream and the flag into a target page among of the plurality of pages; and
in response to determining that the number of bits “0” in the data stream is less than or equal to the number of bits “1” in the data stream, setting the flag as a second value, and writing the data stream and the flag into the target page.

10. The non-volatile memory of claim 9, wherein the data stream or the inversed data stream is written into the plurality of data storage units of the target page, and the flag is written to the at least one flag storage unit of the target page.

11. The non-volatile memory of claim 9, wherein each of the plurality of pages further comprise a plurality of error correction code storage units, and the at least one flag storage unit is located after the plurality of error correction code storage units.

12. The non-volatile memory of claim 9, wherein the at least one flag storage unit is located ahead the plurality of data storage units.

13. The non-volatile memory of claim 9, wherein the flag is one byte.

14. The non-volatile memory of claim 9, wherein a number of bits of the flag is less than a number of the at least one flag storage unit.

15. The non-volatile memory of claim 14, wherein the flag is written into the at least one flag storage unit excluding a first one and a last one of the at least one flag storage unit.

16. The non-volatile memory of claim 9, wherein the non-volatile memory is a flash memory.

17. The non-volatile memory of claim 9, further comprising a page buffer, wherein the controller is further configured to perform: storing the data stream into the page buffer before determining whether the number of bits “0” in the data stream is greater than the number of bits “1” in the data stream.

18. The non-volatile memory of claim 17, wherein the step of inversing the data stream comprises: flipping, by the controller, each bit of the data stream in the page buffer.

19. The non-volatile memory of claim 18, wherein when writing the data stream or the inversed data stream into the target page, a program voltage is applied to a word line associated with the target page, and a program inhibit voltage is applied to a bit line associated with one of the plurality of data storage units, which corresponds to a bit “1” of the page buffer.

20. The non-volatile memory of claim 9, wherein the at least one flag storage unit comprises 8 flag storage units, and the flag is 6 bits.
